(19) United States
(12) Patent Application Publication
(10) Pub. No.: US 2018/0283967 A1
(43) Pub. Date: Oct. 4, 2018

(54) PEDAL OPERATION DETECTING DEVICE

(71) Applicant: ADVICS CO., LTD., Kariya-shi (JP)

(72) Inventor: Shingo KATO, Kariya-shi (JP)

(73) Assignee: ADVICS CO., LTD., Kariya-shi (JP)

(21) Appl. No.: 15/758,104

(22) PCT Filed: Sep. 12, 2016
(86) PCT No.: PCT/JP2016/076802

§ 371 Date: Mar. 7, 2018

(30) Foreign Application Priority Data
Sep. 11, 2015 (JP) 2015-179465

(51) Int. Cl. G01L 5/22

(52) U.S. Cl. CPC G01L 5/225

(57) ABSTRACT

A pedal operation detecting device includes an input member which moves in a first direction in accordance with movement of an operating pedal; a plate-shaped member having a first surface and a second surface, the input member being connected to a central portion of the second surface, and the operating force from the operating pedal being input to the central portion of the second surface, toward one side in the first direction; a limiting unit connected to the second surface so that, when the operating force is input to the plate-shaped member, the plate-shaped member deforms resiliently into a convex shape having an apex portion at a central portion of the first surface, and which limits movement of the plate-shaped member toward the one side in the first direction; and an operating force detecting unit which detects the operating force on the basis of strain in the plate-shaped member.

### TECHNICAL FIELD

The present invention relates to a pedal operation detecting device.

### BACKGROUND ART

A pedal operation detecting device which detects an operating force input to an operating pedal on the basis of strain generated in a member connected to the operating pedal is conventionally known.

### CITATION LIST

### Patent Literature

Patent Literature 1: Japanese Unexamined Patent Application Publication No. 2001-278021

### SUMMARY OF INVENTION

### Technical Problems

In this type of pedal operation detecting device, a deformed mode of a member connected to the operating pedal might affect detection accuracy of the operating force. Therefore, with this type of pedal operation detecting device, it would be meaningful if a novel configuration which may easily improve the detection accuracy of the operating force input to the operating pedal may be obtained.

### Solutions to Problems

A pedal operation detecting device of an embodiment is provided with a support unit, an input member connected to an operating pedal which moves with respect to the support unit when an operating force is input to move in a first direction in accordance with the movement of the operating pedal, a plate-shaped member in a plate shape with a thickness direction in the first direction including a first surface on one side in the first direction and a second surface on the other side in the first direction with the input member connected to a central portion of the second surface to input the operating force from the operating pedal to the central portion of the second surface toward one side in the first direction, a limiting unit connected to the plate-shaped member such that the plate-shaped member deforms resiliently into a convex shape having an apex portion at a central portion of the first surface when the operating force is input from the input member to the plate-shaped member, the limiting unit limiting movement of the plate-shaped member toward one side in the first direction, a resilient portion connected to the plate-shaped member to generate a resilient force against the operating force, and an operating force detecting unit which detects strain generated in the plate-shaped member and detects the operating force on the basis of the detected strain. Therefore, for example, in a case where the operating force is input from the input member to the plate-shaped member, the plate-shaped member deforms resiliently into the convex shape having the apex portion at the central portion of the first surface, so that detection accuracy of the strain generated in the plate-shaped member may be easily improved. Therefore, detection accuracy of the operating force input to the operating pedal is easily improved. Also, as a contact area between the input member and the plate-shaped member is narrower, a biased load is less likely to be applied to the plate-shaped member, so that the detection accuracy of the strain generated in the plate-shaped member is easily improved.

Also, in the pedal operation detecting device, for example, the operating force detecting unit includes a strain detecting element fixed to the plate-shaped member at a position close to a central portion of the plate-shaped member between the central portion of the plate-shaped member and an outer peripheral edge of the plate-shaped member to detect the strain generate in the plate-shaped member. Therefore, for example, the detection accuracy of the strain generated in the plate-shaped member is easily improved. Therefore, detection accuracy of the operating force input to the operating pedal is easily improved. Also, since the input member and the plate-shaped member are connected to each other in the central portion of the plate-shaped member, and the strain detecting elements are fixed around the central portion of the plate-shaped member, in a case where the operating force is input from the input member to the plate-shaped member, a strain amount of the strain detecting element may be increased, so that the detection accuracy of the strain generated in the plate-shaped member may be easily improved.

Also, in the pedal operation detecting device, for example, the resilient portion includes a resilient member connected to the first surface and pushes the plate-shaped member toward the other side in the first direction. Therefore, for example, a reaction force of the operating force input to the operating pedal may be generated by the resilient member.

Also, the pedal operation detecting device is provided with, for example, an operating amount detecting unit, in which the support unit supports the plate-shaped member so as to be movable in the first direction, the resilient member is interposed between the support unit and the first surface, and the operating amount detecting unit detects the movement of the plate-shaped member in the first direction and detects an operating amount of the operating pedal on the basis of the detected movement of the plate-shaped member. Therefore, for example, since the plate-shaped member is used for detecting the operating force and detecting the operating amount, it is easy to inhibit the pedal operation detecting device from becoming large.

Also, in the pedal operation detecting device, for example, the resilient member is connected to the first surface in a position separated from a connecting portion between the second surface and the input member as seen in the first direction. Therefore, for example, it is possible to generate the strain in a portion between the input member and the resilient member in the plate-shaped member.

### BRIEF DESCRIPTION OF DRAWINGS

FIG. 1 is a view illustrating a pedal device according to a first embodiment.

FIG. 2 is a cross-sectional view illustrating a pedal detecting device according to the first embodiment.

FIG. 3 is a view illustrating a second surface side of a plate-shaped member according to the first embodiment.

FIG. 4 is a view illustrating a first surface side of the plate-shaped member of the first embodiment.

FIG. 5 is a view illustrating the pedal detecting device according to the first embodiment, a cross-sectional view illustrating a state in which the plate-shaped member deforms resiliently.

FIG. 6 is a cross-sectional view illustrating a pedal detecting device according to a second embodiment.

FIG. 7 is a view illustrating the pedal detecting device according to the second embodiment, a cross-sectional view illustrating a state in which a plate-shaped member deforms resiliently.

FIG. 8 is a cross-sectional view illustrating a pedal detecting device according to a third embodiment.

FIG. 9 is a view illustrating the pedal detecting device according to the third embodiment, a cross-sectional view illustrating a state in which a plate-shaped member deforms resiliently.

FIG. 10 is a cross-sectional view illustrating a pedal detecting device according to a fourth embodiment.

FIG. 11 is a view illustrating the pedal detecting device according to the fourth embodiment, a cross-sectional view illustrating a state in which a plate-shaped member deforms resiliently.

FIG. 12 is a cross-sectional view illustrating a pedal detecting device according to a fifth embodiment.

FIG. 13 is a view illustrating the pedal detecting device according to the fifth embodiment, a cross-sectional view illustrating a state in which a plate-shaped member deforms resiliently.

FIG. 14 is a cross-sectional view illustrating a pedal detecting device according to a sixth embodiment.

FIG. 15 is a view illustrating the pedal detecting device according to the sixth embodiment, a cross-sectional view illustrating a state in which a plate-shaped member deforms resiliently.

### DESCRIPTION OF EMBODIMENTS

Exemplary embodiments of the present invention are hereinafter disclosed. The configurations of the embodiments described below and actions and effects brought about by the configurations are examples. The present invention may also be realized by a configuration other than the configurations disclosed in the following embodiments. Also, according to the present invention, at least one of various effects obtained by the configurations may be obtained.

Also, in a plurality of embodiments disclosed below, similar components are included. In the following description, the same reference numerals are assigned to the similar components, and explanations are not overlapped.

### First Embodiment

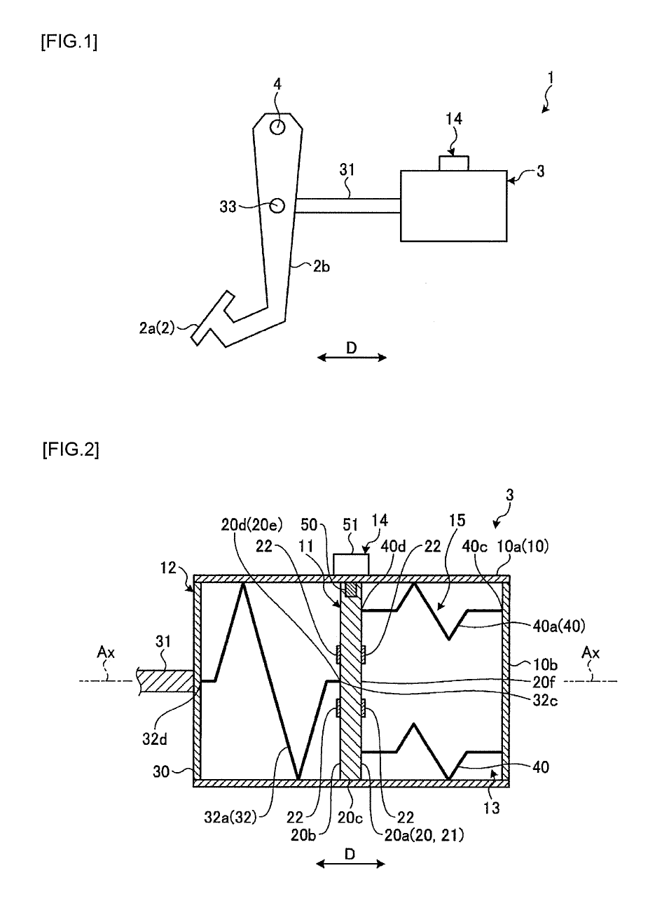

As illustrated in FIG. 1, a pedal device 1 is provided with an operating pedal 2 and a pedal operation detecting device 3 connected to the operating pedal 2. In this embodiment, for example, the pedal device 1 is provided in a vehicle. The operating pedal 2 is, for example, a brake pedal or an accelerator pedal. The pedal operation detecting device 3 detects an operating force input to the operating pedal 2 and an operating amount of the operating pedal 2. Hereinafter, the operating force input to the operating pedal 2 is sometimes simply referred to as the operating force, and the operating amount of the operating pedal 2 is sometimes simply referred to as the operating amount.

The operating pedal 2 is rotatably supported by a vehicle body (not illustrated). The operating pedal 2 includes a pad portion 2a and an arm portion 2b. The pad portion 2a is fixed to one end of the arm portion 2b. The other end of the arm portion 2b is supported by a support shaft 4 so as to be rotatable around the support shaft 4 extending in a direction substantially orthogonal to a first direction D. That is, the operating pedal 2 is provided so as to be rotatable around the support shaft 4. The support shaft 4 is connected to the vehicle body. Herein, the first direction D is, for example, in a front-back direction of the vehicle. One side (right side in FIGS. 1 and 2) in the first direction D is a front side of the vehicle, and the other side (left side in FIGS. 1 and 2) in the first direction D is a back side of the vehicle. When an operator depresses the pad portion 2a toward one side (the right side in FIG. 1) in the first direction D, the operating pedal 2 rotates around the support shaft 4 and the pad portion 2a moves toward one side in the first direction D. Meanwhile, the first direction D may be in a direction orthogonal to the front-back direction of the vehicle.

The pedal operation detecting device 3 is positioned on one side in the first direction D of the operating pedal 2. As illustrated in FIGS. 1 and 2, the pedal operation detecting device 3 is provided with a support unit 10, an operating force detecting unit 11, a plate-shaped member 20, an input unit 12, a limiting unit 13, a resilient portion 15, and an operating amount detecting unit 14.

As illustrated in FIG. 2, the support unit 10 includes a cylindrical portion 10a and a wall portion 10b. The cylindrical portion 10a is formed into an annular shape around a central axis Ax in the first direction D and extends in the first direction D. The wall portion 10b is fixed to an end on one side in the first direction D of the cylindrical portion 10a. The wall portion 10b is formed into a disk shape extending in the direction orthogonal to the first direction D, and closes an opening on one side in the first direction D of the cylindrical portion 10a. The support unit 10 is fixed to a vehicle body. Therefore, the operating pedal 2 moves (rotates) with respect to the support unit 10. The support unit 10 may also be referred to as a support member or a housing.

The input unit 12 includes a moving body 30 and a resilient member 32. The moving body 30 and the resilient member 32 are put into an inner space of the cylindrical portion 10a. The moving body 30 is located on the other side in the first direction D of the wall portion 10b so as to be spaced apart from the wall portion 10b. The resilient member 32 is located between the moving body 30 and the wall portion 10b. The resilient member 32 is an example of an input member.

The moving body 30 is formed into a disk shape extending in the direction orthogonal to the first direction D. The moving body 30 is supported by the cylindrical portion 10a so as to be movable (slidable) in the first direction D. The moving body 30 is connected to the arm portion 2b of the operating pedal 2 via a connecting member 31 and a clevis 33. The moving body 30 moves in the first direction D in accordance with the movement of the operating pedal 2. In detail, when the operating pedal 2 rotates in a direction in which the pad portion 2a moves toward one side in the first direction D, the moving body 30 moves toward one side in the first direction D, and when the operating pedal 2 rotates in a direction in which the pad portion 2a moves toward the other side in the first direction D, the moving body 30 moves toward the other side in the first direction D.

The resilient member 32 is a coil spring. The resilient member 32 includes a coil portion 32a and ends 32c and 32d. The coil portion 32a may expand and contract in the first direction D. The end 32c is included in a tip end of a rod-shaped portion linearly extending from the coil portion 32a toward one side in the first direction D. The end 32d is included in a tip end of a rod-shaped portion linearly extending from the coil portion 32a toward the other side in the first direction D. The end 32d is connected (fixed) to a central portion of the moving body 30. That is, the resilient member 32 is connected to the operating pedal 2 via the moving body 30, the connecting member 31, and the clevis 33. The resilient member 32 moves together with the moving body 30 in the first direction D in accordance with the movement of the operating pedal 2. That is, in a case where the operating pedal 2 rotates in the direction in which the pad portion 2a moves toward one side in the first direction D, the resilient member 32 moves together with the moving body 30 toward one side in the first direction D, and in a case where the operating pedal 2 rotates in the direction in which the pad portion 2a moves toward the other side in the first direction D, the resilient member 32 moves together with the moving body 30 toward the other side in the first direction D. Meanwhile, the resilient member 32 may be a plate spring or the like.

The plate-shaped member 20 is put into the inner space of the cylindrical portion 10a and is located between the resilient member 32 and the wall portion 10b. The plate-shaped member 20 is formed into a disk shape extending in the direction orthogonal to the first direction D. That is, the plate-shaped member 20 is formed into a plate shape with a thickness direction in the first direction D.

The plate-shaped member 20 includes a first surface 20a on one side in the first direction D, a second surface 20b on the other side in the first direction D, that is, on a side opposite to the first surface 20a, and an outer peripheral edge 20c extending between the first and second surfaces 20a and 20b. The first surface 20a and the second surface 20b are formed into a circular shape extending in the direction orthogonal to the first direction D. The plate-shaped member 20 is supported by the cylindrical portion 10a so as to be movable (slidable) in the first direction D. The end 32c of the resilient member 32 is connected to a central portion 20d of the second surface 20b. As an example, the central portion 20d of the second surface 20b and the end 32c of the resilient member 32 are fixed to each other. The operating force is input from the operating pedal 2 to the central portion 20d of the second surface 20b via the resilient member 32 toward one side in the first direction D. The central portion 20d of the second surface 20b is included in a central portion 20e of the plate-shaped member 20. Also, in this embodiment, the plate-shaped member 20 is formed of a plurality of members (main body 21 and magnet 50). The main body 21 includes the first surface 20a, the second surface 20b, and a part of the outer peripheral edge 20c. The main body 21 may be made of, for example, a metal material. The magnet 50 includes a part of the outer peripheral edge 20c and is fixed to the main body 21. The plate-shaped member 20 may also be referred to as a strain body.

The limiting unit 13 includes a plurality of resilient members 40. The plurality of resilient members 40 is put into the inner space of the cylindrical portion 10a and interposed between the first surface 20a of the plate-shaped member 20 and the wall portion 10b of the support unit 10. The plurality of resilient members 40 is located at an interval around the central axis Ax. In this embodiment, as an example, two resilient members 40 are provided, and the central axis Ax is positioned between the two resilient members 40.

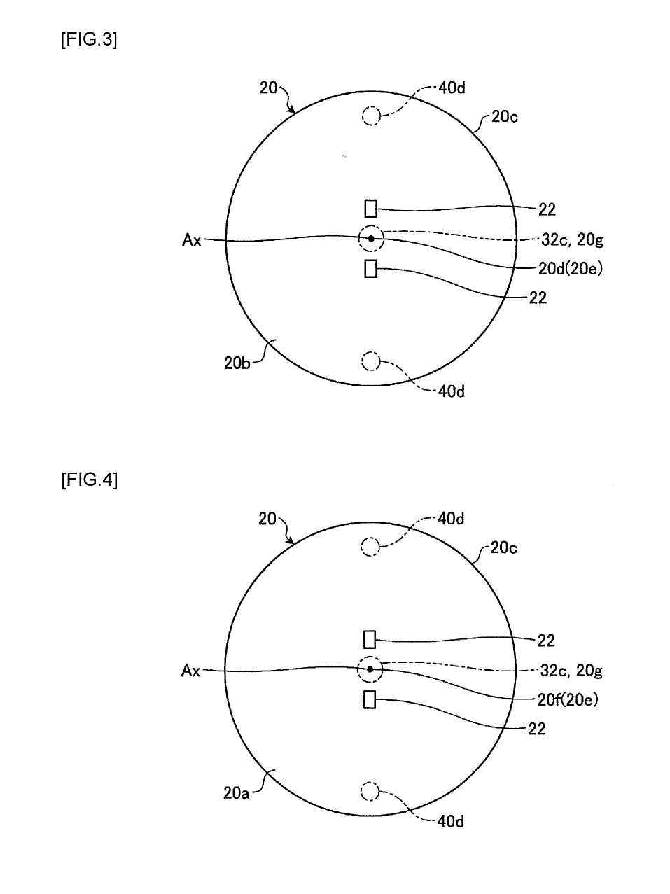

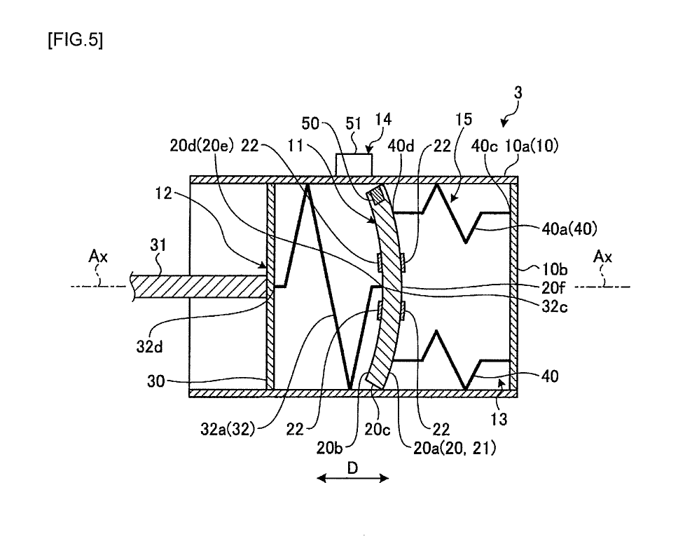

The resilient member 40 includes a coil portion 40a and ends 40c and 40d. The coil portion 40a may expand and contract in the first direction D. The end 40c is included in a tip end of a rod-shaped portion linearly extending from the coil portion 40a toward one side in the first direction D. The end 40d is included in a tip end of a rod-shaped portion linearly extending from the coil portion 40a toward the other side in the first direction D. The end 40c is connected (fixed) to the wall portion 10b. The end 40d is connected (fixed) to the first surface 20a of the plate-shaped member 20. In detail, the ends 40d of the plurality of resilient members 40 are connected to the first surface 20a such that the plate-shaped member 20 deforms resiliently into a convex shape (FIG. 5) having an apex portion at the central portion 20f of the first surface 20a in a case where the operating force is input from the resilient member 32 to the plate-shaped member 20. As an example, as illustrated in FIGS. 3 and 4, the ends 40d of the plurality of resilient members 40 are connected to the first surface 20a in positions separated from a connecting portion 20g between the second surface 20b and the resilient member 32, the positions between which the connecting portion 20g is located as seen in the first direction D. The resilient member 40 is compressed by the operating force input from the plate-shaped member 20, and generates a resilient force to push the plate-shaped member 20 toward the other side in the first direction D. The limiting unit 13 limits the movement of the plate-shaped member 20 toward one side in the first direction D by the plurality of resilient members 40. Meanwhile, a spring constant of the resilient member 40 may be the same as or different from a spring constant of the resilient member 32. Also, the resilient member 32 may be a plate spring or the like.

The resilient portion 15 includes the resilient members 32 and 40. That is, the resilient portion 15 is connected to the plate-shaped member 20. Also, when the operating force is input, the resilient members 32 and 40 generate the resilient force against the operating force, that is, a reaction force.

As illustrated in FIGS. 2 to 4, the operating force detecting unit 11 includes the plate-shaped member 20 and a plurality of (four as one example) strain detecting elements 22 provided on the plate-shaped member 20. The operating force detecting unit 11 detects strain generated in the plate-shaped member 20 by the strain detecting elements 22, and detects the operating force on the basis of the detected strain. The strain detecting element 22 may be formed of a strain gauge. As an example, in this embodiment, two strain detecting elements 22 are fixed to each of the first surface 20a and the second surface 20b of the plate-shaped member 20. Each strain detecting element 22 is fixed to the plate-shaped member 20 at a position closer to the central portion 20e of the plate-shaped member 20 between the central portion 20e of the plate-shaped member 20 and the outer peripheral edge 20c of the plate-shaped member 20. In a case where the plate-shaped member 20 deforms resiliently into the convex shape having the apex portion at the central portion 20f of the first surface 20a, the two strain detecting elements 22 fixed to the first surface 20a are subjected to tension deformation, and the two strain detecting elements 22 fixed to the second surface 20b are subjected to compression deformation. Also, the operating force detecting unit 11 includes a detecting circuit including a bridge circuit formed of a plurality of strain detecting elements 22. The detecting circuit outputs an electric signal (operating force) corresponding to the strain of the plate-shaped member 20.

The operating amount detecting unit 14 detects the movement of the plate-shaped member 20 in the first direction D and detects the operating amount of the operating pedal 2 on the basis of the detected movement of the plate-shaped member 20. In detail, the operating amount detecting unit 14 includes the magnet 50 and a detecting circuit 51. The magnet 50 is included in the plate-shaped member 20. The detecting circuit 51 is fixed to an outer surface of the cylindrical portion 10a of the support unit 10. When the magnet 50 (plate-shaped member 20) moves in the first direction D, a magnetic force of the magnet 50 acting on the detecting circuit 51 changes. The detecting circuit 51 detects the change in magnetic force according to the change in the position of the magnet 50, detects a moving amount (displacing amount) from an initial position of the plate-shaped member 20 on the basis of the detected change in magnetic force, and outputs an electric signal (operating amount) corresponding to the detected moving amount of the plate-shaped member 20. Herein, the initial position of the plate-shaped member 20 is the position (FIG. 2) in a case where the operating force does not act. Meanwhile, a configuration of the operating amount detecting unit 14 is not limited to that which detects the movement of the plate-shaped member 20 in the first direction D using the magnetic force. For example, the operating amount detecting unit 14 may be configured to optically detect the movement of the plate-shaped member 20 in the first direction D or the like.

In the above-described configuration, when the operating pedal 2 is depressed toward one side in the first direction D by the operator, the operating force transmitted from the operating pedal 2 to the moving body 30 via the connecting member 31 pushes the moving body 30, the resilient member 32, the plate-shaped member 20, and the resilient member 40 toward one side in the first direction D. At that time, as illustrated in FIG. 5, the moving body 30, the resilient member 32, and the plate-shaped member 20 move toward one side in the first direction D. Also, at that time, the resilient members 32 and 40 are subjected to compression deformation to generate a force to push the operating pedal 2 toward the other side in the first direction D, that is, the resilient force serving as the reaction force of the operating force. Also, at that time, the plate-shaped member 20 deforms resiliently into the convex shape having the apex portion at the central portion 20f of the first surface 20a. That is, strain is generated in the plate-shaped member 20. The operating amount detecting unit 14 detects the strain generated in the plate-shaped member 20 by the strain detecting element 22, and detects the operating force on the basis of the detected strain. Also, the operating amount detecting unit 14 detects the movement of the plate-shaped member 20 in the first direction D, and detects the operating amount of the operating pedal 2 on the basis of the detected movement of the plate-shaped member 20.

As described above, in the embodiment, the resilient member 32 is connected to the central portion 20d of the second surface 20b, and the operating force is input from the operating pedal 2 to the central portion 20d of the second surface 20b toward one side in the first direction D. Also the limiting unit 13 is connected to the second surface 20b such that the plate-shaped member 20 deforms resiliently into the convex shape having the apex portion at the central portion 20f of the first surface 20a in a case where the operating force is input from the resilient member 32 to the plate-shaped member 20. Therefore, for example, in a case where the operating force is input from the resilient member 32 to the plate-shaped member 20, the plate-shaped member 20 deforms resiliently into the convex shape having the apex portion at the central portion 20f of the first surface 20a. As a result, an eccentric load is inhibited from acting on the plate-shaped member 20, so that the deformation having the apex portion at a portion other than the central portion 20e may not occur. Therefore, detection accuracy of the strain generated in the plate-shaped member 20 is easily improved. Therefore, detection accuracy of the operating force input to the operating pedal 2 is easily improved. Also, as a contact area between the resilient member 32 and the plate-shaped member 20 is narrower, a biased load is less likely to be applied to the plate-shaped member 20, so that the detection accuracy of the strain generated in the plate-shaped member 20 is easily improved.

Also, in this embodiment, the strain detecting element 22 is fixed to the plate-shaped member 20 at a position closer to the central portion 20e of the plate-shaped member 20 between the central portion 20e of the plate-shaped member 20 and the outer peripheral edge 20c of the plate-shaped member 20 and detects the strain generated in the plate-shaped member 20. Therefore, for example, the detection accuracy of the strain generated in the plate-shaped member 20 is easily improved. Therefore, detection accuracy of the operating force input to the operating pedal 2 is easily improved. Also, since the resilient member 32 and the plate-shaped member 20 are connected to each other in the central portion 20e of the plate-shaped member 20, and the strain detecting elements 22 are fixed around the central portion 20e of the plate-shaped member 20, in a case where the operating force is input from the resilient member 32 to the plate-shaped member 20, a strain amount of the strain detecting element 22 may be increased, so that the detection accuracy of the strain generated in the plate-shaped member 20 may be easily improved.

Also, in this embodiment, the resilient portion 15 includes the resilient member 40 connected toward the first surface 20a to push the plate-shaped member 20 toward the other side in the first direction D. Therefore, for example, the reaction force of the operating force input to the operating pedal 2 may be generated by the resilient member 40.

Also, in this embodiment, the operating amount detecting unit 14 detects the movement of the plate-shaped member 20 in the first direction D, and detects the operating amount of the operating pedal 2 on the basis of the detected movement. Therefore, for example, since the plate-shaped member 20 is used for detecting the operating force and detecting the operating amount, it is easy to inhibit the pedal operation detecting device 3 from becoming large.

Also, in this embodiment, the resilient member 40 is connected to the first surface 20a at a position separated from the connecting portion 20g between the second surface 20b and the resilient member 32 as seen in the first direction D. Therefore, for example, it is possible to generate strain in a portion between the resilient member 32 and the resilient member 40 in the plate-shaped member 20.

Also, in this embodiment, since the resilient portion 15 is integrally provided on the pedal operation detecting device 3, compared with a case where the resilient portion 15 is provided separately from the pedal operation detecting device 3, the pedal device 1 may be easily made compact.

Meanwhile, in this embodiment, the number of resilient members 40 is not limited to two, and may be three or more. In this case, three or more resilient members 40 may be located at regular intervals around the central axis Ax.

### Second Embodiment

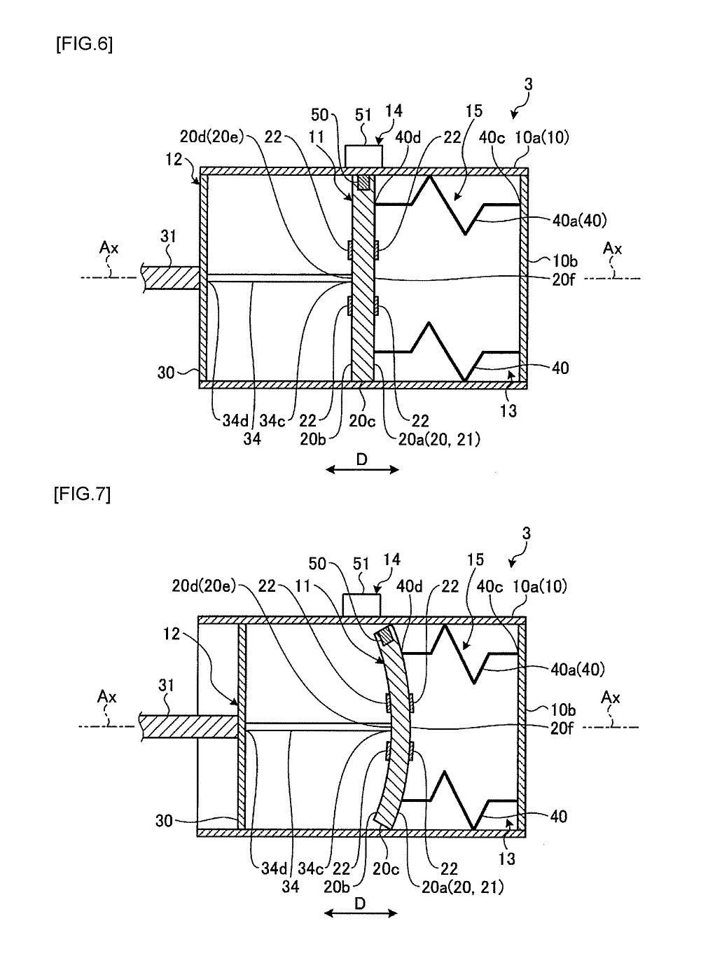

A pedal device 1 of this embodiment illustrated in FIGS. 6 and 7 has a configuration similar to that of the pedal device 1 of the first embodiment. Therefore, in this embodiment also, the similar effect based on the configuration similar to that of the first embodiment may be obtained.

However, in this embodiment, an input unit 12 of a pedal operation detecting device 3 is provided with a rod-shaped member 34 in place of a resilient member 32. The rod-shaped member 34 is put into an inner space of a cylindrical portion 10a. The rod-shaped member 34 extends in a first direction D. The rod-shaped member 34 includes an end 34c on one side in the first direction D and an end 34d on the other side in the first direction D. The end 34d is connected (fixed) to a central portion of a moving body 30. That is, the rod-shaped member 34 is connected to an operating pedal 2 via the moving body 30, a connecting member 31 and a clevis 33. The end 34c is connected to a central portion 20d of a second surface 20b of a plate-shaped member 20. As an example, the end 34c and the central portion 20d of the second surface 20b are fixed to each other. Also, in this embodiment, a resilient portion 15 is formed of a plurality of resilient members 40.

In the above-described configuration, in a case where the operating pedal 2 is depressed toward one side in the first direction D by an operator, an operating force transmitted from the operating pedal 2 to the moving body 30 via the connecting member 31 pushes the moving body 30, the rod-shaped member 34, the plate-shaped member 20, and the resilient member 40 toward one side in the first direction D. At that time, as illustrated in FIG. 7, the moving body 30, the rod-shaped member 34, and the plate-shaped member 20 move toward one side in the first direction D. Also, at that time, the resilient member 40 is subjected to compression deformation and generates a force to push the operating pedal 2 toward the other side in the first direction D, that is, a resilient force serving as a reaction force of the operating force. At that time, the plate-shaped member 20 deforms resiliently into a convex shape having an apex portion at a central portion 20f of the first surface 20a. That is, strain is generated in the plate-shaped member 20.

As described above, in this embodiment, since an input member is the rod-shaped member 34, a deformation response of the plate-shaped member 20 with respect to the operating force is easily improved. Therefore, a response of the operating amount detecting unit 14 and the operating amount detecting unit 14 is easily improved.

### Third Embodiment

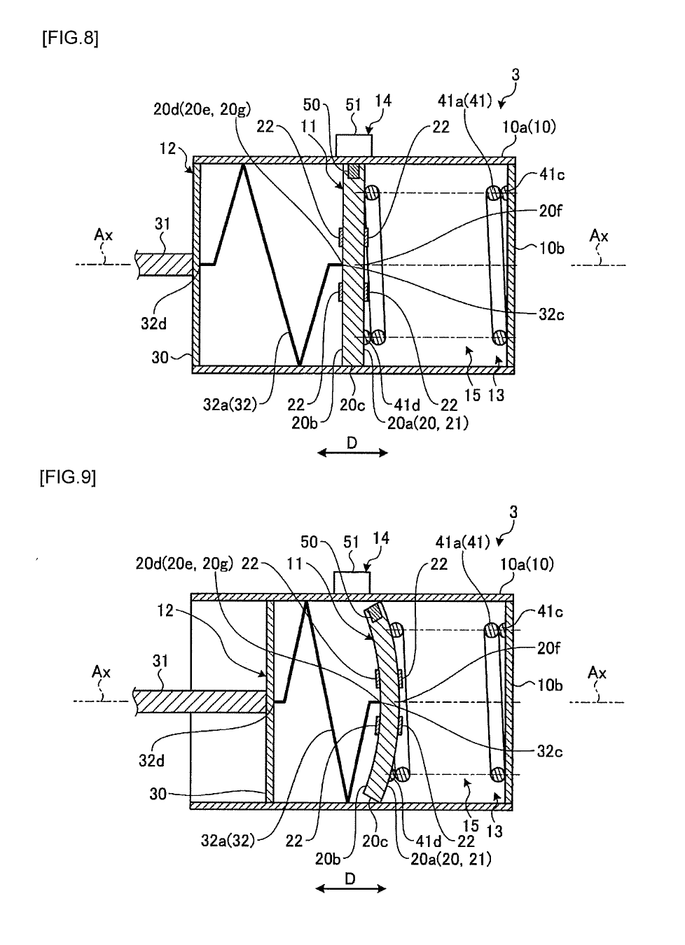

A pedal device 1 of this embodiment illustrated in FIGS. 8 and 9 has a configuration similar to that of the pedal device 1 of the first embodiment. Therefore, in this embodiment also, the similar effect based on the configuration similar to that of the first embodiment may be obtained.

However, in this embodiment, a limiting unit 13 of a pedal operation detecting device 3 is provided with one resilient member 41 in place of a plurality of resilient members 40. The resilient member 41 is put into an inner space of a cylindrical portion 10a and is interposed between a first surface 20a of a plate-shaped member 20 and a wall portion 10b of a support unit 10. The resilient member 41 includes a coil portion 41a and ends 41c and 41d. The coil portion 41a may expand and contract in a first direction D. The coil portion 41a is formed into a spiral shape around a central axis Ax. The end 41c is included in a portion on one side in the first direction D of the coil portion 41a and the end 41d is included in a portion on the other side in the first direction D of the coil portion 41a. The ends 41c and 41d are formed into a shape to enclose the central axis Ax. For example, the ends 41c and 41d are formed into an annular shape or a C shape. The end 41c is connected (fixed) to the wall portion 10b, and the end 40d is connected (fixed) to the first surface 20a of the plate-shaped member 20.

Also, the end 41d of the resilient member 41 is connected to the first surface 20a such that the plate-shaped member 20 deforms resiliently into a convex shape (FIG. 9) having an apex portion at a central portion 20f of the first surface 20a in a case where the operating force is input from the resilient member 32 to the plate-shaped member 20. As an example, in this embodiment, the end 41d is connected to the first surface 20a in a position separated from a connecting portion 20g between the second surface 20b and the resilient member 32, the position enclosing the connecting portion 20g between the second surface 20d and the resilient member 32 as seen in the first direction D. The resilient member 41 is compressed resiliently by the operating force input from the plate-shaped member 20, and generates a resilient force to push the plate-shaped member 20 toward the other side in the first direction D. The limiting unit 13 limits the movement of the plate-shaped member 20 toward one side in the first direction D by the resilient member 41.

Also, in this embodiment, the resilient portion 15 is formed of a resilient member 32 and the resilient member 41.

In the above-described configuration, when the operating pedal 2 is depressed toward one side in the first direction D by an operator, the operating force transmitted from the operating pedal 2 to a moving body 30 via a connecting member 31 pushes the moving body 30, the resilient member 32, the plate-shaped member 20, and the resilient member 41 toward one side in the first direction D. At that time, as illustrated in FIG. 9, the moving body 30, the resilient member 32, and the plate-shaped member 20 move toward one side in the first direction D. Also, at that time, the resilient members 32 and 41 are subjected to compression deformation to generate a force to push the operating pedal 2 toward the other side in the first direction D, that is, the resilient force serving as the reaction force of the operating force. At that time, the plate-shaped member 20 deforms resiliently into a convex shape having an apex portion at a central portion 20f of the first surface 20a. That is, strain is generated in the plate-shaped member 20.

As described above, in this embodiment, since the limiting unit 13 is formed of one resilient member 41, a configuration of the limiting unit 13 may be easily simplified.

### Fourth Embodiment

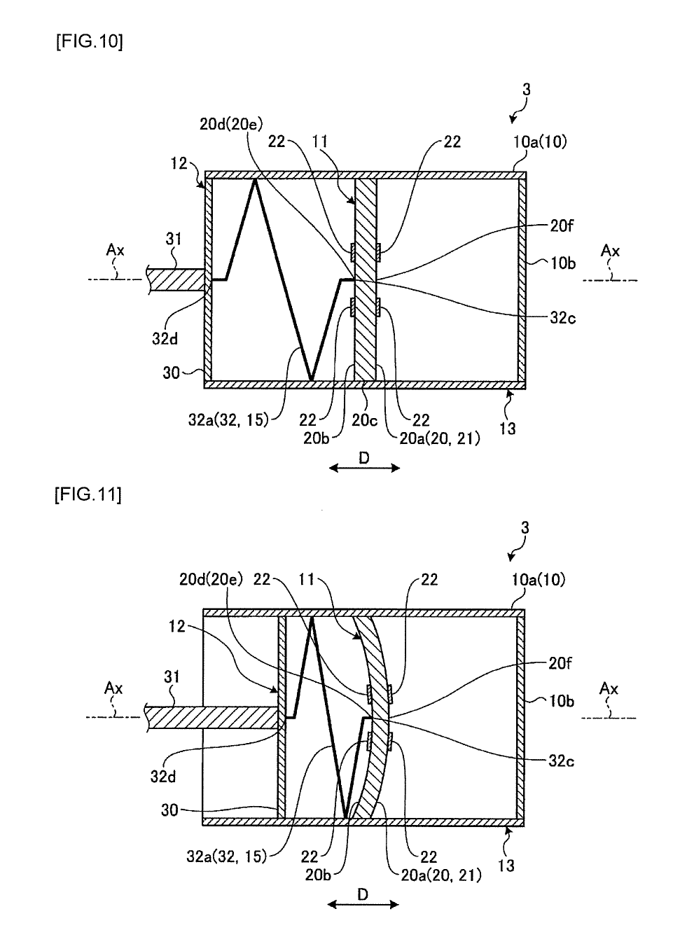

A pedal device 1 of this embodiment illustrated in FIGS. 10 and 11 has a configuration similar to that of the pedal device 1 of the first embodiment. Therefore, in this embodiment also, the similar effect based on the configuration similar to that of the first embodiment may be obtained.

However, in this embodiment, an operating amount detecting unit 14 is not provided. Also, a plate-shaped member 20 is fixed to a support unit 10 so as to be resiliently deformable. In detail, an outer peripheral edge 20c of the plate-shaped member 20 is fixed to a cylindrical portion 10a of the support unit 10. As an example, an entire outer peripheral edge 20c is fixed to the cylindrical portion 10a. Also, a magnet 50 is not provided on the plate-shaped member 20, and the plate-shaped member 20 is formed of a main body 21.

Also, in this embodiment, a plurality of resilient members 40 is not provided. In this embodiment, a limiting unit 13 is formed of the cylindrical portion 10a (support unit 10), and limits movement of the plate-shaped member 20 toward one side in a first direction D by the cylindrical portion 10a. Also, in this embodiment, a resilient portion 15 is formed of a resilient member 32.

In the above-described configuration, when the operating pedal 2 is depressed toward one side in the first direction D by an operator, the operating force transmitted from the operating pedal 2 to a moving body 30 via a connecting member 31 pushes the moving body 30, a resilient member 32, and the plate-shaped member 20 toward one side in the first direction D. At that time, as illustrated in FIG. 11, the moving body 30 and the resilient member 32 move toward one side in the first direction D. Also, at that time, the resilient member 32 is subjected to compression deformation and generates a force to push the operating pedal 2 toward the other side in the first direction D, that is, a resilient force serving as a reaction force of the operating force. At that time, the plate-shaped member 20 deforms resiliently into a convex shape having an apex portion at a central portion 20f of the first surface 20a. That is, the cylindrical portion 10a is connected to the plate-shaped member 20 such that the plate-shaped member 20 deforms resiliently into the convex shape having the apex portion at the central portion 20f of the first surface 20a in a case where the operating force is input from the resilient member 32 to the plate-shaped member 20.

As described above, in this embodiment, since the operating amount detecting unit 14 is not provided, a configuration of a pedal operation detecting device 3 may be easily simplified.

### Fifth Embodiment

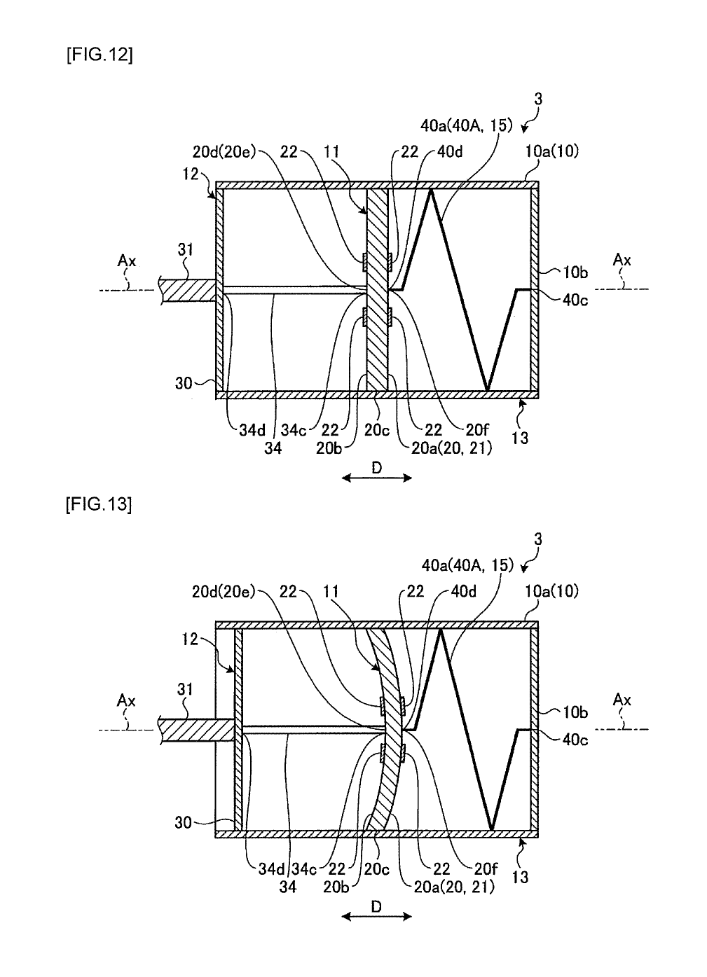

A pedal device 1 of this embodiment illustrated in FIGS. 12 and 13 has a configuration similar to that of the pedal device 1 of the fourth embodiment. Therefore, in this embodiment also, the similar effect based on the configuration similar to that of the fourth embodiment may be obtained.

However, in this embodiment, an input unit 12 of a pedal operation detecting device 3 is provided with a rod-shaped member 34 in place of a resilient member 32. The rod-shaped member 34 has a configuration and arrangement similar to those of the rod-shaped member 34 of the second embodiment.

Also, in this embodiment, a resilient portion 15 includes one resilient member 40A. The resilient member 40A is put into an inner space of a cylindrical portion 10a and is interposed between a first surface 20a of a plate-shaped member 20 and a wall portion 10b of a support unit 10. The resilient member 40A includes a coil portion 40a and ends 40c and 40d. The coil portion 40a may expand and contract in the first direction D. The end 40c is included in a tip end of a rod-shaped portion linearly extending from the coil portion 40a toward one side in the first direction D. The end 40d is included in a tip end of a rod-shaped portion linearly extending from the coil portion 40a toward the other side in the first direction D. The end 40c is connected (fixed) to a central portion of the wall portion 10b. The end 40d is connected (fixed) to a central portion 20f of the first surface 20a of the plate-shaped member 20. The resilient member 40A is compressed resiliently by the operating force input from the plate-shaped member 20, and generates a resilient force to push the plate-shaped member 20 toward the other side in the first direction D.

In the above-described configuration, in a case where an operating pedal 2 is depressed toward one side in the first direction D by an operator, an operating force transmitted from the operating pedal 2 to a moving body 30 via a connecting member 31 pushes a moving body 30, a rod-shaped member 34, the plate-shaped member 20, and the resilient member 40A toward one side in the first direction D. At that time, as illustrated in FIG. 13, the moving body 30, the rod-shaped member 34, and the plate-shaped member 20 move toward one side in the first direction D. Also, at that time, the resilient member 40A is subjected to compression deformation and generates a force to push the operating pedal 2 toward the other side in the first direction D, that is, a resilient force serving as a reaction force of the operating force. At that time, the plate-shaped member 20 deforms resiliently into a convex shape having an apex portion at a central portion 20f of the first surface 20a. That is, strain is generated in the plate-shaped member 20.

As described above, in this embodiment, since an input member is the rod-shaped member 34, a deformation response of the plate-shaped member 20 with respect to the operating force is easily improved. Therefore, a response of the operating amount detecting unit 14 is easily improved.

### Sixth Embodiment

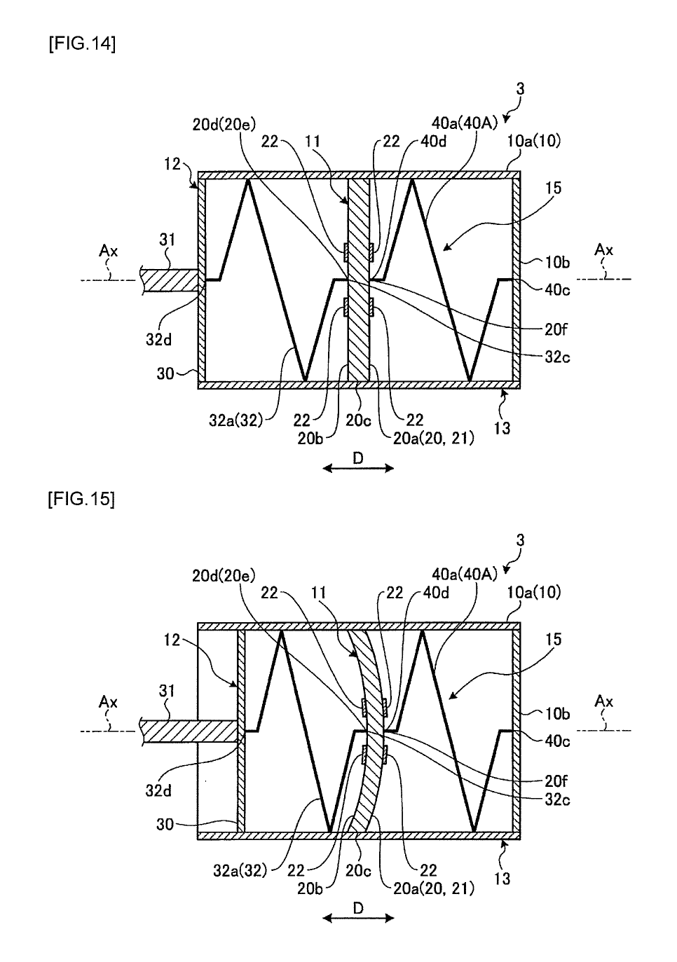

A pedal device 1 of this embodiment illustrated in FIGS. 14 and 15 has a configuration similar to that of the pedal device 1 of the fourth embodiment. Therefore, in this embodiment also, the similar effect based on the configuration similar to that of the fourth embodiment may be obtained.

However, in this embodiment, a resilient portion 15 includes a resilient member 40A in addition to a resilient member 32. The resilient member 40A has a configuration and arrangement similar to those in the fifth embodiment.

In the above-described configuration, when an operating pedal 2 is depressed toward one side in a first direction D by an operator, an operating force transmitted from the operating pedal 2 to a moving body 30 via a connecting member 31 pushes the moving body 30, the resilient member 32, the plate-shaped member 20, and the resilient member 40A toward one side in the first direction D. At that time, as illustrated in FIG. 15, the moving body 30 and the resilient member 32 move toward one side in the first direction D. Also, at that time, the resilient members 32 and 40A are subjected to compression deformation and generate a force to push the operating pedal 2 toward the other side in the first direction D, that is, a resilient force serving as a reaction force of the operating force. At that time, the plate-shaped member 20 deforms resiliently into a convex shape having an apex portion at a central portion 20f of the first surface 20a. That is, strain is generated in the plate-shaped member 20.

Meanwhile, in the above description, numbers such as “first” and “second” are attached to some components, but these numbers are attached for convenience of explanation, and may be appropriately exchanged.

Although the embodiments of the present invention are exemplified above, the embodiments described above are merely an example, and it is not intended to limit the scope of the invention. The above-described embodiments may be implemented in various other forms, and variously omitted, replaced, combined, and changed without departing from the gist of the invention. Also, the specifications (structure, type, direction, shape, size, length, width, thickness, height, number, arrangement, position, material and the like) such as a configuration and a shape may be appropriately changed to be implemented. For example, the plate-shaped member 20 may be polygonal.

1. A pedal operation detecting device comprising:
a support unit;
an input member connected to an operating pedal which moves with respect to the support unit when an operating force is input to move in a first direction in accordance with the movement of the operating pedal;
a plate-shaped member in a plate shape with a thickness direction in the first direction including a first surface on one side in the first direction and a second surface on the other side in the first direction with the input member connected to a central portion of the second surface to input the operating force from the operating pedal to the central portion of the second surface toward one side in the first direction;
a limiting unit connected to the plate-shaped member such that the plate-shaped member deforms resiliently into a convex shape having an apex portion at a central portion of the first surface when the operating force is input from the input member to the plate-shaped member, the limiting unit limiting movement of the plate-shaped member toward one side in the first direction;
a resilient portion connected to the plate-shaped member to generate a resilient force against the operating force; and
an operating force detecting unit that detects strain generated in the plate-shaped member and detects the operating force on the basis of the detected strain.

2. The pedal operation detecting device according to claim 1,
wherein the operating force detecting unit includes a strain detecting element fixed to the plate-shaped member at a position close to a central portion of the plate-shaped member between the central portion of the plate-shaped member and an outer peripheral edge of the plate-shaped member to detect the strain generated in the plate-shaped member.

3. The pedal operation detecting device according to claim 1,
wherein the resilient portion includes a resilient member connected to the first surface and pushes the plate-shaped member toward the other side in the first direction.

4. The pedal operation detecting device according to claim 3, comprising
an operating amount detecting unit,
wherein the support unit supports the plate-shaped member so as to be movable in the first direction,
the resilient member is interposed between the support unit and the first surface, and
the operating amount detecting unit detects the movement of the plate-shaped member in the first direction and detects an operating amount of the operating pedal on the basis of the detected movement of the plate-shaped member.

5. The pedal operation detecting device according to claim 3,
wherein the resilient member is connected to the first surface in a position separated from a connecting portion between the second surface and the input member as seen in the first direction.

6. The pedal operation detecting device according to claim 4,
wherein the resilient member is connected to the first surface in a position separated from a connecting portion between the second surface and the input member as seen in the first direction.

7. The pedal operation detecting device according to claim 2,
wherein the resilient portion includes a resilient member connected to the first surface and pushes the plate-shaped member toward the other side in the first direction.

8. The pedal operation detecting device according to claim 7,
wherein the resilient member is connected to the first surface in a position separated from a connecting portion between the second surface and the input member as seen in the first direction.

9. The pedal operation detecting device according to claim 7, comprising
an operating amount detecting unit,
wherein the support unit supports the plate-shaped member so as to be movable in the first direction,
the resilient member is interposed between the support unit and the first surface, and
the operating amount detecting unit detects the movement of the plate-shaped member in the first direction and detects an operating amount of the operating pedal on the basis of the detected movement of the plate-shaped member.

10. The pedal operation detecting device according to claim 9,
wherein the resilient member is connected to the first surface in a position separated from a connecting portion between the second surface and the input member as seen in the first direction.
